(19) United States
(12) Patent Application Publication
(10) Pub. No.: US 2007/0075287 A1
(43) Pub. Date: Apr. 5, 2007

(54) Regulator union swivel connection

(75) Inventor: David M. Lechner, Clarence, NY (US)

Correspondence Address: David C. Jenkins;Eckert Seamans Cherin & Mellott, LLC, 44th Floor, 600 Grant Street, Pittsburgh, PA, 15219, US

(73) Assignee: Harsco Technologies Corporation, Fairmont, MN (US)

(21) Appl. No.: 11/244,248

(22) Filed: Oct. 5, 2005

(51) Int. Cl. F16L 29/00

(52) U.S. Cl. 251/148

(57) ABSTRACT

A pressure regulator having a housing with at least two fluid couplings and a pressure control mechanism disposed in the housing. The pressure control mechanism disposed between, and in fluid communication with, the at least two fluid couplings. There is at least one swivel connector coupled to at least one of the at least two fluid couplings.

### BACKGROUND OF THE INVENTION

1. Field of the Invention

This application relates to a regulator and, more specifically, to a regulator having a swivel connector at the inlet and/or the outlet coupling.

2. Background Information

A gas service regulator is typically disposed between a combustible gas supply or source and a use device. Thus, gas service regulators may be commonly disposed between the supply system and a home. Such gas service regulators include a housing defining one or more chambers, a pressure regulating device having a valve, and at least two fluid couplings; an inlet and an outlet. The inlet and outlet couplings are structured to be coupled to, respectively, a gas supply conduit and an exhaust conduit. The inlet and the outlet needed to tightly engage the supply and exhaust conduits to prevent a combustible gas leak. In operation, high pressure gas from the supply conduit acted upon the pressure regulating device causing the valve to open. A quantity of gas entered one of the housing chambers until the pressure inside the housing increased to a point where the valve closed again. The pressure in the housing was typically lower than the pressure in the supply conduit. As the gas in the chamber was used, the pressure decreased so that the high pressure gas in the supply conduit forced the valve open again. This cycle was constantly repeated.

In the prior art, the inlet and an outlet were rigidly connected to, or formed as a part of, the housing. The inlet and an outlet each included an opening which was threaded. In one configuration, the inlet and outlet openings were generally aligned with each other, and, in another configuration, the inlet and outlet openings were perpendicular to each other. The gas supply conduit and exhaust conduit were, typically, round pipes having externally threaded ends. These externally threaded ends were structured to engage the housing openings. Thus, for example, when a regulator with perpendicular openings was installed, the regulator was initially coupled to one conduit. For the sake of this example, the regulator inlet will be said to be coupled to the supply conduit first. To couple the regulator to the supply conduit, the user would rotate the regulator while the inlet opening threads engaged the supply conduit threads. Unfortunately, when the regulator inlet was tightly coupled to the supply conduit, the outlet was not always in a position to engage the exhaust conduit. Thus, the user was left with two equally unacceptable choices: either over tighten the regulator or loosen the regulator until the outlet and the exhaust conduit were aligned.

There is, therefore, a need for a regulator having at least one swivel connector which would allow a user to reposition the regulator while maintaining a sealed coupling.

There is a further need for a regulator having at least one swivel connector that may be used with previously installed infrastructure.

### SUMMARY OF THE INVENTION

These needs, and others, are satisfied by present invention which provides a regulator having at least one swivel connector. The swivel connector is a simple design having a sealed fitting rotatably disposed in an opening on the regulator. The fitting is, generally, an elongated tube. The fitting includes a threaded end structured to engage either a supply or exhaust conduit. A sealing member is disposed on the outer side of the fitting and engages the housing thereby creating the seal. A retaining element secures the fitting to the housing and generally prevents axial movement while allowing the fitting to rotate within the housing. Thus, in operation, a user may couple the regulator to, for example, the supply conduit. If, after the inlet fitting is brought into tight engagement with the supply conduit, the regulator outlet is not aligned with the exhaust conduit, the user simply rotates the regulator so that the outlet and the exhaust conduit align. The fitting may also include a gasket that substantially reduces the infiltration of contamination from outside the regulator.

### BRIEF DESCRIPTION OF THE DRAWINGS

A full understanding of the invention can be gained from the following description of the preferred embodiments when read in conjunction with the accompanying drawings in which:

FIG. 1 is a cross-sectional view of a regulator.

FIG. 2 is a cross-sectional view of an inlet coupling.

FIG. 3 is a cross-sectional view of an outlet coupling.

### DESCRIPTION OF THE PREFERRED EMBODIMENTS

As used herein the phrase “sealing member” is an element structured to substantially prevent the flow of fluid between two or more other elements. A sealing member includes, but is not limited to, an O-ring, quad-ring, cup seal, or a pressure assisted seal.

As used herein, a “retaining element” is an element structured to substantially prevent the disassociation of two or more other elements. A includes, but is not limited to, pins (roll, cotter, etc.), whole or partial rings, clips, set screws, set screws with collar and threaded collars or nuts.

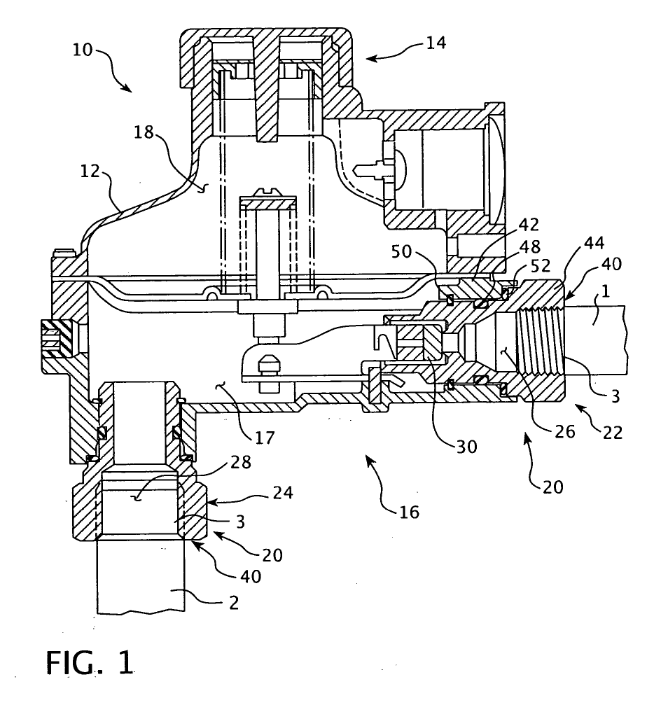

As shown on FIG. 1, a regulator 10 includes a housing 12 and a pressure control mechanism 14. As described in greater detail below, the regulator 10 is structured to be coupled to a supply conduit 1 and to an exhaust conduit 2, each of which have a threaded end 3. Both the supply conduit 1 and exhaust conduit 2 are structured to convey a fluid, preferably combustible gas. The fluid in the supply conduit 1 is at a relatively higher pressure than the atmosphere or the exhaust conduit 2. The housing 12 defines a plurality of chambers 16 including a first chamber 17 and a second chamber 18. The housing 12 further includes at least two fluid couplings 20 including an inlet 22 and an outlet 24. The pressure control mechanism 14 is disposed between, and in fluid communication with, the at least two fluid couplings 20. Each fluid coupling 20 includes a passage 26, 28, which is, preferably, generally circular. Each fluid coupling 20 is in fluid communication with the first chamber 17. The pressure control mechanism 14 is disposed within the housing 12 and includes a valve member 30. As detailed below, the valve member 30 is disposed in the flow path of the inlet 22, which is further coupled to a fluid at a high pressure. The pressure control mechanism 14 is structured to move the valve member 30 between a first, closed position and a second, open position, as described below.

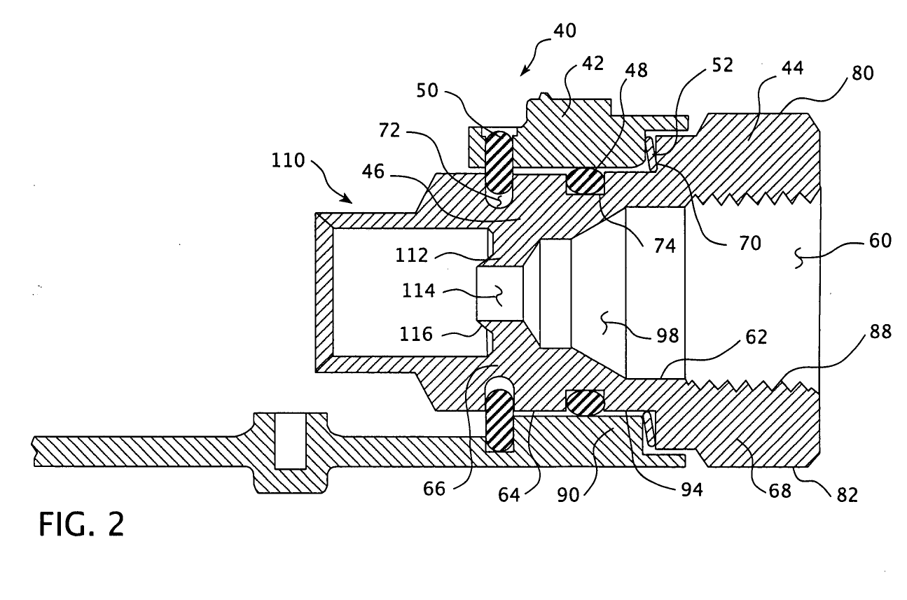

At least one of the at least two fluid couplings 20 has a swivel connector 40. The swivel connector 40 is structured to be sealingly coupled to the housing 12 while further being rotatable within the housing 12. Thus, the regulator 10 may be coupled to a supply or exhaust conduit 1, 2 and still be rotated relative to that conduit 1, 2. The swivel connector 40 is structured to be disposed in either, or both, the inlet passage 26 or the outlet passage 28. The swivel connector 40 includes a housing component 42, which is incorporated into the housing 12 as described below, and a fitting 44. The fitting 44 includes a body 46, a compressible sealing member 48 and a retaining element 50. The fitting 44 may also include a gasket 52. The fitting body 46 is an elongated, generally circular body with a passage 60 therethrough. Thus, as shown on FIG. 2, the fitting body 46 has an inner surface 62 and an outer surface 64. The fitting body 46 also has two distinct portions, a first portion 66 and a second portion 68, which may have different diameters. That is, the fitting body 46 has a first portion 66 sized to extend into the housing 12 and a second portion 68, which may have a greater diameter, structured to be disposed outside of the housing 12. The fitting body 46 may have an intermediate flange 70, that is, a step extending generally perpendicular to the longitudinal axis of the fitting body 46, on the outer surface 64 near the transition between the first portion 66 and the second portion 68.

The fitting body 46 further includes a retaining element groove 72 and a sealing member groove 74. Both the retaining element groove 72 and the sealing member groove 74 are, preferably, disposed on the first portion 66 with the sealing member groove 74 disposed between the retaining element groove 72 and the flange 70. The sealing member groove 74 is sized with a depth less than the thickness of the sealing member 48 so that, prior to compression of the sealing member 48, as described below, the sealing member 48 extends partially above the sealing member groove 74. Similarly, the retaining element groove 72 is sized with a depth less than the thickness of the retaining element 50 so that, when installed, the retaining element 50 extends partially above the retaining element groove 72.

The second portion 68 of the fitting body 46 includes threads 88 on the inner surface 62 that are structured to engage the threaded end 3 to a supply conduit 1 or an exhaust conduit 2. The outer surface 64 of the second portion 68, preferably, has a gripping surface 80. The gripping surface 80 may be textured or may have a plurality of flat surfaces 82 structured to be engaged by a tool (not shown).

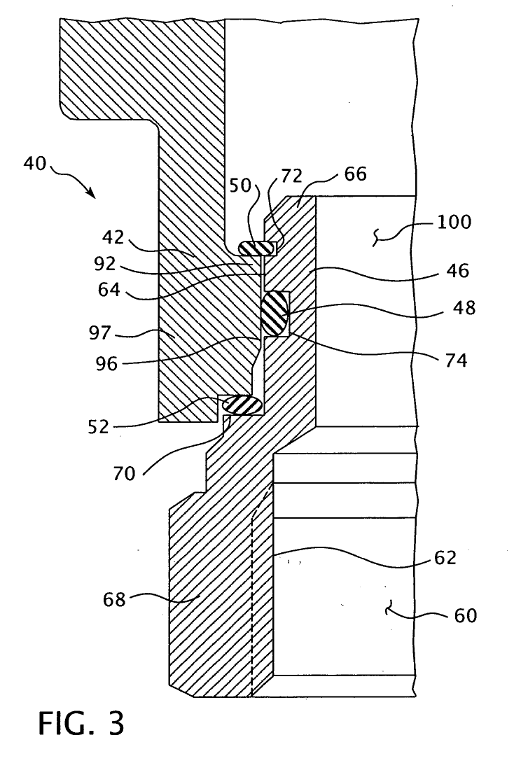

Preferably, each housing passage 26, 28 includes an internal collar 90 (FIG. 2), 92 (FIG. 3) which is the swivel connector housing component 42. Each collar 90, 92 has an inner surface 94, 96 with a diameter smaller than the associated housing passage 26, 28. The internal collar 90 (FIG. 2), 92 (FIG. 3) is preferably created by providing a thicker sidewall extending inwardly. That is, in the preferred embodiment, the outer surface of the housing passage 26, 28 is aligned with the outer surface of the internal collar 90 (FIG. 2), 92 (FIG. 3) so that the housing passage 26, 28 and internal collar 90 (FIG. 2), 92 (FIG. 3) have a seamless transition on the outer surface. Each collar 90, 92 defines a narrow passage 98, 100 within the associated passage 26, 28. When the housing passages 26, 28 include a collar 90, 92, the fitting body first portion 66 outer surface 64 is sized slightly smaller than the narrow passage 98, 100. Thus, the fitting body first portion 66 will only just fit within the narrow passage 98, 100. The retaining element 50 has an outer diameter that is greater than the collar 90, 92 inner diameter.

In this configuration, the swivel connector 40 is assembled as follows. The sealing member 48 is disposed on the fitting body 46 partially within the sealing member groove 74. The fitting body 46 is then inserted into one of the housing passages 26, 28 with the first portion 66 extending through the associated narrow passage 98, 100. Once the first portion 66, and more specifically, the retaining element groove 72, is disposed beyond a collar 90, 92, the retaining element 50 is installed so that the retaining element 50 extends, partially, into the retaining element groove 72 while the retaining element 50 outer diameter extends beyond the collar 90, 92 inner diameter. Thus, the retaining element 50 thereby prevents removal of the fitting body 46 from the housing passages 26, 28 while allowing the fitting body 46 to rotate in the housing passages 26, 28. Further, because the fitting body 46 first portion 66 will only just fit within the narrow passage 98, 100 and because the sealing member groove 74 is sized with a depth less than the thickness of the sealing member 48 so that the sealing member 48 extends partially above the sealing member groove 74, the sealing member 48 is compressed and sealingly engages the collar inner surface 94, 96.

Accordingly, a user may first couple the regulator 10 to, for example, a supply conduit 1 by coupling the swivel connector 40 at the inlet 22 to the supply conduit 1. That is, the user may thread the fitting body second portion threads 88 to the threaded end 3 of a supply conduit 1. The user may use a tool on the flat surfaces 82 to ensure a tight fit. Once the regulator 10 is tightly coupled to the supply conduit 1, the user may still rotate the regulator 10 relative to the supply conduit 1 so that the outlet 24 aligns with the exhaust conduit 3. The rotation of the regulator 10 is accomplished while the fitting 44 remains sealingly coupled to the housing 12.

The fitting 44, and more preferably the fitting 44 disposed in the inlet 22, may also be adapted to cooperate with the pressure control mechanism 14. That is, as shown in FIG. 2, the pressure control mechanism 14 valve member 30 may be structured to engage a regulator device interface 110 on the fitting body 46. Preferably, the fitting body first portion 66 includes a platform 112 extending from the inner surface 62 and generally perpendicular to the longitudinal axis of the fitting body 42. The platform 112 includes an opening 114 which is a portion of the fitting passage 60. The opening 114 may further have a raised ridge 116 extending thereabout. In operation, the pressure control mechanism 14 is structured to move the valve member 30 between a first, closed position wherein the valve member 30 engages the raised ridge 116 and a second, open position, wherein the valve member 30 is spaced from the fitting body 46. As is known in the art, the valve member 30 is responsive to a relatively low pressure within the first chamber 17. That is, when the pressure in the first chamber 17 is low, the high pressure gas in the supply conduit 1 moves the valve member 30 to the second, open position. When the pressure in the first chamber 17 is increased, the valve member 30 returns to the first, closed position and gas is exhausted from the regulator 10 via the exhaust conduit 2. Eventually, the pressure in the first chamber 17 is reduced and the cycle repeats.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A pressure regulator comprising:
a housing having at least two fluid couplings;
a pressure control mechanism disposed in said housing, said pressure control mechanism disposed between, and in fluid communication with, said at least two fluid couplings; and
at least one swivel connector coupled to at least one of said at least two fluid couplings.

2. The pressure regulator of claim 1 wherein:
said at least one of said at least two fluid couplings includes a generally circular passage in said housing;
said at least one swivel connector including a fitting structured to be rotatably disposed in said housing passage.

3. The pressure regulator of claim 2 wherein:
said swivel connector fitting includes an elongated body, a sealing member, and a retaining element;
said body having a passage therethrough, an outer surface and an inner surface;
said body sized slightly smaller than said housing passage and disposed therein;
said sealing member sealingly disposed between said fitting body outer surface and said housing passage,
said retaining element engaging said fitting body and said housing, thereby preventing removal of said fitting body from said housing passage while allowing said fitting body to rotate in said housing passage.

4. The pressure regulator of claim 3 wherein:
said fitting body includes an intermediate flange on said outer surface, said flange extending generally perpendicular to a fitting body longitudinal axis;
said swivel connector further including a gasket, said gasket disposed about said fitting body adjacent said flange; and
wherein said gasket engages said flange and said housing.

5. The pressure regulator of claim 3 wherein said fitting body outer surface has a gripping surface.

6. The pressure regulator of claim 5 wherein said gripping surface is a plurality of flat surfaces structured to be engaged by a tool.

7. The pressure regulator of claim 1 wherein:
said at least one fluid coupling having a swivel connector coupled thereto includes an opening having a generally circular passage in said housing with an inner surface;
said inner surface having an inwardly extending collar having a diameter and defining a narrow passage within said passage;
said at least one swivel connector having a fitting, a sealing member, and a retaining element;
said fitting having a generally circular, elongated body with a first portion and a second portion, and a passage extending therethrough with an inner surface;
said first portion having an outer surface sized slightly smaller than said collar diameter and disposed within said narrow passage, said first portion further having a retaining element groove;
said sealing member disposed sealingly between said first portion outer surface and said collar;
said retaining element disposed partially within said retaining element groove, said retaining element further partially engaging said collar thereby by preventing removal of said fitting body from said housing passage while allowing said fitting body to rotate in said housing passage;
said second portion extending from said housing passage, said second portion passage inner surface structured to engage a fluid conduit.

8. The pressure regulator of claim 7 wherein:
said fitting body includes a flange between said first portion outer surface and said second portion, said flange extending generally perpendicular to a fitting body longitudinal axis;
said at least one swivel connector further including a gasket, said gasket disposed about said fitting body adjacent said flange; and
wherein said gasket engages said flange and said collar.

9. The pressure regulator of claim 7 wherein said second portion includes an outer surface having a gripping surface.

10. The pressure regulator of claim 9 wherein said gripping surface is a plurality of flat surfaces structured to be engaged by a tool.

11. The pressure regulator of claim 1 wherein:
said at least two fluid couplings includes a fluid inlet and a fluid outlet; and
said at least one swivel connector coupled to said fluid inlet.

12. The pressure regulator of claim 11 wherein:
said inlet includes an opening having a generally circular passage in said housing with an inner surface;
said inner surface having an inwardly extending collar having a diameter and defining a narrow passage within said passage;
said at least one swivel connector having a fitting, a sealing member, and a retaining element;
said fitting having a generally circular, elongated body with a first portion and a second portion, and a passage extending therethrough with an inner surface;
said first portion having an outer surface sized slightly smaller than said flange diameter and disposed within said narrow passage, said first portion further having a retaining element groove;
said sealing member disposed sealingly between said first portion outer surface and said collar;
said retaining element disposed partially within said retaining element groove, said retaining element further partially engaging said collar thereby by preventing removal of said fitting body from said housing passage while allowing said fitting body to rotate in said housing passage;
said second portion extending from said housing passage, said second portion passage inner surface structured to engage a fluid conduit.

13. The pressure regulator of claim 12 wherein:
said fitting body first portion includes a regulator device interface, said interface including a platform with an opening; and
said platform extending perpendicularly to the longitudinal axis of said fitting body within said fitting passage, whereby said platform opening is a portion of said fitting passage.

14. The pressure regulator of claim 13 wherein said platform includes a raised ridge disposed about said platform opening and structured to engage a seal on said pressure control mechanism.

15. The pressure regulator of claim 12 wherein:
said fitting body includes a flange between said first portion outer surface and said second portion, said flange extending generally perpendicular to a fitting body longitudinal axis;
said at least one swivel connector further including a gasket, said gasket disposed about said fitting body adjacent said flange; and
wherein said gasket engages said flange and said collar.

16. The pressure regulator of claim 12 wherein said second portion includes an outer surface having a gripping surface.

17. The pressure regulator of claim 16 wherein said gripping surface is a plurality of flat surfaces structured to be engaged by a tool.

18. The pressure regulator of claim 11 wherein a swivel connector is coupled to said fluid outlet.

19. The pressure regulator of claim 19 wherein each said swivel connector is structured to engage a fluid conduit.
